(19) United States
(12) Patent Application Publication
(10) Pub. No.: US 2008/0089294 A1
(43) Pub. Date: Apr. 17, 2008

(54) Performing handover using mutual authentication in wireless broadband (WiBro) network

(76) Inventors: Tae-Shik Shon, Suwon-si (KR); Sun-Woong Choi, Seoul (KR); Sun-Gi Kim, Seoul (KR); Kang-Young Moon, Yongin-si (KR)

Correspondence Address: ROBERT E. BUSHNELL, 1522 K STREET NW, SUITE 300, WASHINGTON, DC, 20005-1202, US

(21) Appl. No.: 11/890,521

(22) Filed: Aug. 7, 2007

(30) Foreign Application Priority Data
Oct. 13, 2006 (KR) 10-2006-0099900

(51) Int. Cl. H04Q 7/00

(52) U.S. Cl. 370/331

(57) ABSTRACT

A method and system to perform a handover using mutual authentication in a Wireless Broadband (WiBro) network includes: generating a temporary number of a mobile station needing handover from a first base station to a second base station and requesting a handover from the first base station; transferring a handover request message, including a field for storing the temporary number of the mobile station, from the first base station to the second base station according to the handover request of the mobile station; transferring a handover response message, including respective fields for storing the mobile station's temporary number and the second base station's certification encoded using an authentication key received from an authentication server, from the second base station to the first base station; verifying the encoded temporary number of the mobile station and the encoded certification of the second base station in the handover response message transferred from the second base station, and transferring a handover acknowledge (ACK) message including a field for storing an authentication result for the second base station, from the first base station to the second base station; transmitting an initial communication request message, including a Control Mobile Attenuation Code (CMAC) value to be authenticated by the second base station, from the mobile station to the second base station; and authenticating the mobile station and transmitting a response message to the initial communication request message, from the second base station to the mobile station in response to the CMAC value transmitted from the mobile station being the same as a CMAC value of the second base station.

### CLAIM OF PRIORITY

This application makes reference to, incorporates the same herein, and claims all benefits accruing under 35 U.S.C. §119 from an application for METHOD AND SYSTEM FOR PERFORMING HANDOVER USING MUTUAL AUTHENTICATION IN WIBRO NETWORK earlier filed in the Korean Intellectual Property Office on 13 Oct. 2006 and there duly assigned Serial No. 2006-99900.

### BACKGROUND OF THE INVENTION

1. Field of the Invention

The present invention relates to a method and system to perform a handover using mutual authentication in a Wireless Broadband (WiBro) network, and more particularly, the present invention relates to a method and system to perform a handover using mutual authentication in a WiBro network that minimizes an authentication procedure required between a mobile station and a new target base station, and to perform a handover using efficient mutual authentication during a handover process in a mobile WiBro system.

2. Description of the Related Art

With rapid development of computer, electronic and communication technology, a variety of wireless communication services using a wireless network are being provided. Due to this, services provided by a mobile communication system using a wireless communication network are extending to multimedia communication service transferring data, such as circuit data, packet data, etc. as well as voice service.

Lately, the development of information and communication technology has led to commercialization of International Mobile Telecommunication 2000 (IMT-2000), e.g., Code Division Multiple Access (CDMA) 2000 1× and 3× evolution data only (EV-DO), wideband CDMA (WCDMA), etc., that is a third generation mobile communication system established as a standard by International Telecommunication Union-Radio communication sector (ITU-R).

IMT-2000 is a mobile communication system aimed at direct global roaming for personal mobility and service mobility, the same call quality level as a wired telephone, high-speed packet data service, various application services implemented by combining a wired network with a wireless network, and so on. According to IMT-2000, it is possible to improve the quality of conventional voice and Wireless Application Protocol (WAP) services and also to provide a variety of multimedia services, e.g., Audio on Demand (AOD), Video on Demand (VOD), etc., at a higher rate.

However, since a mobile communication system necessitates high cost for base station construction, a wireless Internet service charge is high. Also, the screen size of a mobile communication terminal is small and thus limits available content. Consequently, in a mobile communication system, it is difficult to provide high-speed wireless Internet service.

In addition, since there is a limit to Wireless Local Area Network (WLAN) technology being able to provide public service due to problems in electric wave interference, small coverage, etc., WiBro that enables people to use high-speed wireless Internet service at a low charge while ensuring portability and mobility is coming into the limelight. Such WiBro is defined in the Institute of Electrical and Electronics Engineers (IEEE) 802.16e standard.

According to WiBro service, it is possible to access the Internet and use a variety of information and content using a WiBro terminal, e.g., a notebook computer, a Personal Digital Assistant (PDA), a handheld Personal Computer (PC), etc., in indoor and outdoor static environments and in walking-speed and low and medium-speed mobile environments. In addition, a WiBro system is an Internet Protocol (IP)-based wireless data system providing mobility of 60 km/h and having an asymmetric up/downlink transmission characteristic of 24.8 Mbps downlink transmission rate and 5.2 Mbps uplink transmission rate.

A WiBro terminal supports various additional functions, such as a camera function, a portable storage function, etc., as well as a wireless Internet function.

Particularly, a WiBro (802.16e) terminal performs wireless communication with a WiBro base station, which is referred to as a BS, and then is connected to an Internet network by wire. A BS is connected to a core network of a service provider, and an Authentication, Authorization and Accounting (AAA) server for authenticating a user and a device is located at one side of the core network.

Even when a user moves from the coverage of a BS to the coverage of another BS, WiBro (802.16e) service is seamless. However, when an authentication process is included in such a handover process, it is impossible to provide seamless service.

IEEE 802.16e standard document [1] defines a method of performing complete re-authentication, such as initial network entry when handover is needed, and a method of shortening an authentication process using a HandOver (HO) optimization flag.

Authentication upon initial network entry means full authentication in which all processes including a security negotiation process of a Serving Base Station (SBC)-REQuest (REQ)/ReSPonse (RSP), a Privacy Key Management (PKM) Extensible Authentication Protocol (EAP) process, a Security Association and Traffic Encryption Key (SA-TEK) process, and a TEK creation process, etc., are performed. On the other hand, when the HO optimization flag is used, parts of the process, such as the above-mentioned PKM EAP process and SA-TEK process, are skipped, thereby performing a shortened authentication process.

Such conventional art fundamentally necessitates additional authentication message exchange between a target BS and a Mobile Station (MS). In other words, full authentication in a handover process involves SBC negotiation, PKM EAP phase, SA-TEK phase, TEK creation phase, etc., thereby affecting the providing of seamless service during movement. There is a method of shortening an authentication process using an HO optimization flag [1] to provide an efficient authentication function rather than full authentication. However, the method using HO optimization has some problems, as described below.

When bit #1 of the HO optimization flag is used, the PKM EAP process in the authentication process is skipped. However, an SA-TEK 3-way handshake process checking the legitimacy of a security context between the target BS and the MS is necessary, as is a TEK creation process. Consequently, the PKM EAP phase may be skipped, but authentication messages are additionally exchanged 5 times, and a 128 bit key is created, thereby causing performance problems.

In addition, when bit #2 of the HO optimization flag is used, all the processes from security negotiation to TEK creation can be skipped, but a reliable relation must have been established between the MS and the target BS to which the MS will be connected. Therefore, in the case of bit #2 of the HO optimization flag, a mutual authentication process is omitted, which may cause the problem of a masquerading MS and BS.

### SUMMARY OF THE INVENTION

It is an object of the present invention to provide a method and system to perform a handover using mutual authentication in a network, including an authentication process indispensable for a conventional handover process in a basic handover process, thereby improving security using a more efficient handover function and a mutual authentication function.

A first aspect of the present invention provides a method of performing handover using mutual authentication in a Wireless Broadband (WiBro) network, the method including: generating, at a mobile station wanting handover from a first base station to a second base station, a temporary number of the mobile station itself and requesting the first base station for handover; transferring, at the first base station, a handover request message including a field for storing the temporary number of the mobile station to the second base station according to the handover request of the mobile station; transferring, at the second base station, a handover response message including respective fields for storing the mobile station's temporary number and the second base station's certification encoded using an authentication key received from an authentication server to the first base station; verifying, at the first base station, the encoded temporary number of the mobile station and the encoded certification of the second base station in the handover response message transferred from the second base station, and transferring a handover acknowledge (ACK) message including a field for storing an authentication result for the second base station to the second base station; transmitting, at the mobile station, an initial communication request message including a Control Mobile Attenuation Code (CMAC) value to be authenticated by the second base station to the second base station; and when the CMAC value transmitted from the mobile station is the same as a CMAC value of the second base station, authenticating, at the second base station, the mobile station and transmitting a response message to the initial communication request message to the mobile station.

In transferring the handover request message to the second base station, the handover request message may be relayed to the second base station by the authentication server.

In transferring the handover request message to the second base station, the temporary number of the mobile station may be the mobile station's nonce value for authenticating the second base station.

In transferring the handover response message to the first base station, the handover response message may be relayed to the first base station by the authentication server.

In transferring the handover response message to the first base station, the temporary number of the mobile station may be the mobile station's nonce value for authenticating the second base station, and the certification of the second base station may be a certification of the second base station's manufacturer or Application Service Provider (ASP).

In transferring the handover ACK message to the second base station, the handover ACK message may be relayed to the second base station by the authentication server.

In transferring the handover ACK message to the second base station, the first base station may decode the encoded temporary number of the mobile station and the encoded certification of the second base station in the handover response message, and transfer the handover ACK message including the field for storing an authentication result for the second base station to the second base station, when the decoded temporary number of the mobile station is the same as a temporary number of the mobile station that the first base station has, and the certification of the second base station is normal.

In transmitting the initial communication request message to the second base station, the mobile station may generate the CMAC value using a CMAC key generated from the authentication key shared with the second base station and the temporary number of the mobile station, and then transmit the initial communication request message including the CMAC value to the second base station.

In transmitting the response message to the initial communication request message to the mobile station, the second base station may authenticate the mobile station and transmit the response message to the initial communication request message to the mobile station when the CMAC value of the mobile station is the same as the CMAC value generated using a CMAC key generated from the authentication key of the second base station.

In particular, when the CMAC value of the mobile station is the same as the CMAC value generated using the CMAC key, the second base station may authenticate the mobile station by certifying identity of the authentication key and the mobile station's temporary number.

A second aspect of the present invention provides a method of authenticating a handover target base station in a WiBro network, the method including: generating, at a mobile station wanting handover from a first base station to a second base station, a temporary number of the mobile station itself and requesting the first base station for handover; transferring, at the first base station, a handover request message including a field for storing the temporary number of the mobile station to the second base station according to the handover request of the mobile station; transferring, at the second base station, a handover response message including respective fields for storing the mobile station's temporary number and the second base station's certification encoded using an authentication key received from an authentication server to the first base station; and verifying, at the first base station, the encoded temporary number of the mobile station and the encoded certification of the second base station in the handover response message transferred from the second base station, and transferring a handover acknowledge (ACK) message including a field for storing an authentication result for the second base station to the second base station.

A third aspect of the present invention provides a method of authenticating a mobile station in a WiBro network, the method including: transmitting, at the mobile station, an initial communication request message including a CMAC value to be authenticated by a second base station to which the mobile station wants handover to the second base station; and when the CMAC value transmitted from the mobile station is the same as a CMAC value of the second base station, authenticating, at the second base station, the mobile station and transmitting a response message to the initial communication request message to the mobile station.

A fourth aspect of the present invention provides a system to perform a handover using mutual authentication in a WiBro network, the system including: a mobile station for generating its own temporary number and requesting a first base station for handover when requesting handover from the first base station to a second base station; the first base station for transferring a handover request message including a field for storing the temporary number of the mobile station to the second base station according to the handover request of the mobile station; and the second base station for transferring a handover response message including respective fields for storing the mobile station's temporary number and the second base station's certification encoded using an authentication key received from an authentication server connected through a network, to the first base station. Here, the first base station verifies the encoded temporary number of the mobile station and the encoded certification of the second base station in the handover response message transferred from the second base station, and transfers a handover ACK message including a field for storing an authentication result for the second base station to the second base station. When an initial communication request message including a CMAC value is received from the mobile station, and the received CMAC value of the mobile station is the same as a CMAC value of the second base station, then the second base station authenticates the mobile station and transmits a response message to the initial communication request message to the mobile station.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a view of the configuration of a mobile Wireless Broadband (WiBro) network according to an embodiment of the present invention;

FIG. 2 is a view of a handover process performed using mutual authentication in a WiBro network according to an exemplary embodiment of the present invention;

FIG. 3 is a view of the format of a HandOver (HO)-request message in a Target Base Station (TBS) authentication process of FIG. 2;

FIG. 4 is a view of the format of an HO-response message in the TBS authentication process of FIG. 2; and

FIG. 5 is a view of the format of an HO-acknowledge message in the TBS authentication process of FIG. 2.

### DETAILED DESCRIPTION OF THE INVENTION

Hereinafter, exemplary embodiments of the present invention are described in detail with reference to the accompanying drawings. In the following description, a detailed description of known functions and configurations incorporated herein has been omitted for conciseness. The following description refers to exemplary embodiments in which the present invention is applied to a method and system for performing handover using mutual authentication in a Wireless Broadband (WiBro) network. It should be noted that the following exemplary embodiments are merely to help with understanding the present invention, and thus are not to be interpreted as limiting the scope of the present invention.

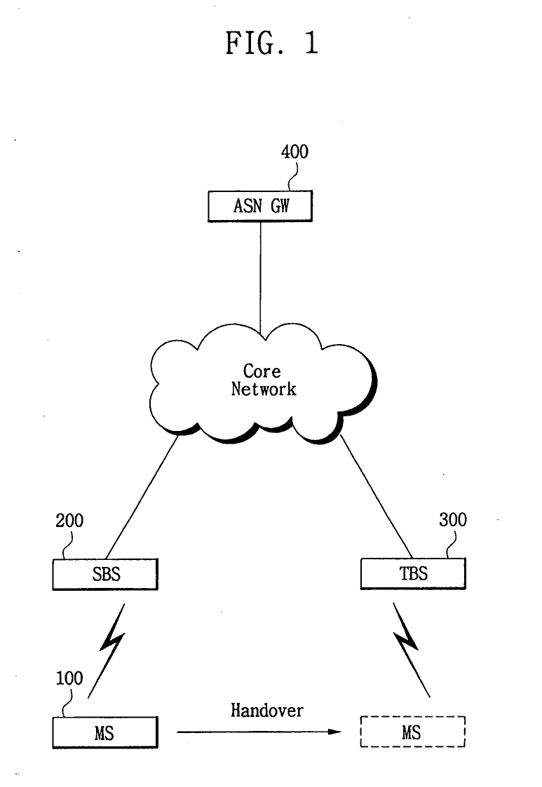

FIG. 1 is a view of the configuration of a mobile WiBro network according to the present invention.

As illustrated in FIG. 1, the mobile WiBro system of the present invention includes a Mobile Station (MS) 100, a Serving Base Station (SBS) 200, a Target Base Station (TBS) 300, and an Access Service Network GateWay (ASN GW) 400.

The MS 100 is connected to the SBS 200 and is receiving wireless communication service. The MS 100 has already performed a mutual authentication process with the SBS 200 before attempting HandOver (HO) to the TBS 300, and is sharing a security context, such as an authentication key, etc. with the SBS 200.

When the MS 100 wants handover to the TBS 300 while receiving service in the service area of the SBS 200, it generates a nonce value for the SBS 200 to begin a challenge-response process for authenticating the TBS 300 and transmits a HO-request message MOB_MSHO-REQ including the generated nonce value to the SBS 200.

In information technology, a nonce is a parameter that varies with time. A nonce can be a time stamp, a visit counter on a Web page, or a special marker intended to limit or prevent the unauthorized replay or reproduction of a file.

The SBS 200 is a base station for providing wireless communication service to MSs in the service area. When the HO-request message MOB_MSHO-REQ is received from the MS 100, the SBS 200 transfers a request message for handover HO-Request (MSID and Nonce) to the TBS 300.

The HO-request message HO-Request (MSID and Nonce) transferred from the SBS 200 is relayed to the TBS 300 by the ASN GW 400.

An MSID included in the HO-request message HO-Request (MSID and Nonce) that the SBS 200 transfers to the TBS 300 is an IDentification (ID) of the MS 100, and a nonce denotes a nonce value for the SBS 200 to begin a challenge-response process for authenticating the TBS 300.

The TBS 300 is a base station to which handover of the MS 100 is performed. The TBS 300 receives the HO-request message HO-Request (MSID and Nonce) transferred from the SBS 200 and requests the ASN GW 400 for an Authorization Key (AK) context of the MSID. When the related information is received, the TBS 300 transfers a modified HO-response message HO-Response (E_{AK}[Nonce//Cert]) to the HO-request message HO-Request (MSID and Nonce) transferred from the SBS 200 to the SBS 200 via the relay of the ASN GW 400. The TBS 300 encodes the nonce and a certification included in the modified HO-response message HO-Response (E_{AK}[Nonce//Cert]) using the AK, and transfers them.

The SBS 200 verifies the encoded nonce and the encoded certification in the modified handover response message HO-Response (E_{AK}[Nonce//Cert]) received from the TBS 300, and transfers a modified HO-acknowledge message to provide an authentication result for the TBS 300 to the TBS 300 via the ASN GW 400.

In other words, when the modified HO-response message HO-Response (E_{AK}[Nonce//Cert]) is received from the TBS 300, the SBS 200 decodes the encoded nonce and the encoded certification and compares the decoded nonce value with a nonce value that the SBS 200 has. When the decoded nonce value is the same as the nonce value of the SBS 200, and the decoded certification is a normal one, the SBS 200 transfers the modified HO-acknowledge message to provide an authentication result for the TBS 300 to the TBS 300 via the ASN GW 400. The certification denotes a TBS manufacturer's certification or a TBS Application Service Provider's (ASP)'s certification.

The ASN GW 400 also serves as an Authentication, Authorization and Accounting (AAA) server. Even when the role of the ASN GW 400 is separated from that of an AAA server, the present invention can be applied in the same way.

When the authentication process for the TBS 300 is finished, the MS 100 transmits a MOB_HO-IND message to the SBS 200, and the SBS 200 transfers a HO_confirm (Traffic Encryption Key (TEK) context) message to the TBS 300 that is verified by the ASN GW 400.

The TBS 300 transfers a HO-acknowledge message to the HO_confirm (TEK context) message transferred from the SBS 200 to the SBS 200 via the ASN GW 400.

In addition, the MS 100 transmits a ranging request (RNG-REQ) (Control Mobile Attenuation Code (CMAC) or Hashed Message Attenuation Code (HMAC)) message to be authenticated by the TBS 300 to the TBS 300. The MS 100 and the TBS 300 are already sharing the same AK and thus can generate a CMAC key or HMAC key from the AK and a nonce, respectively. In other words, in the ranging process, the MS 100 generates a CMAC value for the ranging message using a CMAC key and then transmits it to the TBS 300.

When the CMAC value is received from the MS 100, and a CMAC value generated using the CMAC key of the TBS 300 is the same as the CMAC value transmitted from the MS 100, the TBS 300 authenticates the ranging message itself and also the MS 100 by certifying that the AK and nonce of the TBS 300 are the same as those of MS 100. Then, the TBS 300 transmits a ranging response (RNG-RSP) (CMAC or HMAC) message to the RNG-REQ (CMAC or HMAC) message transmitted from the MS 100 to the MS 100.

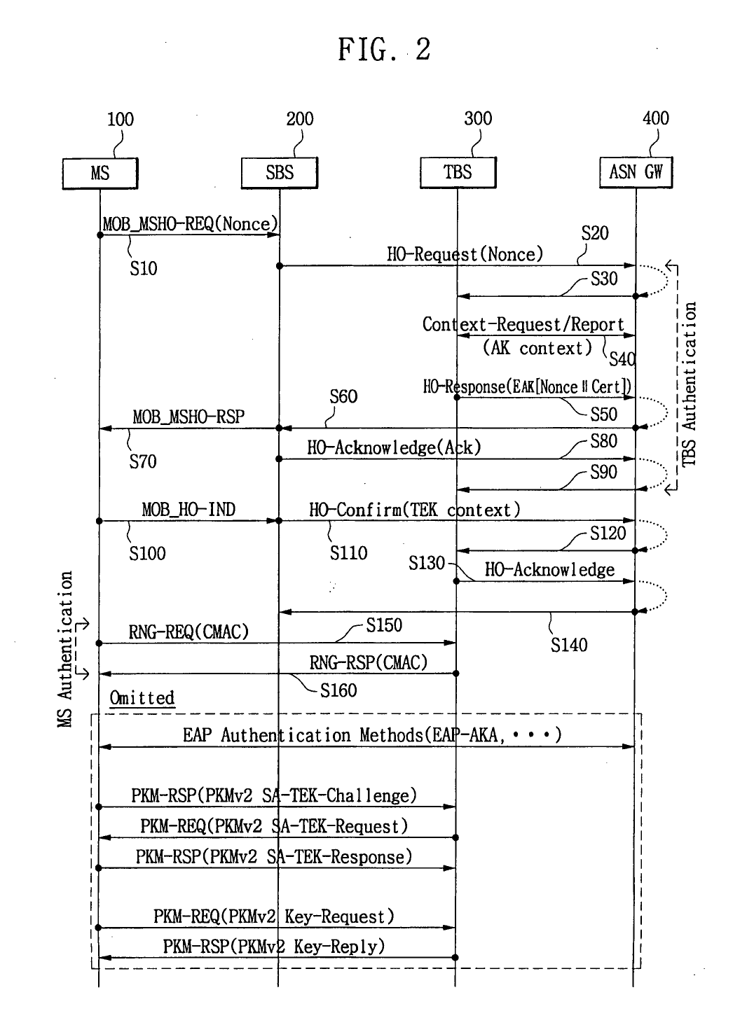

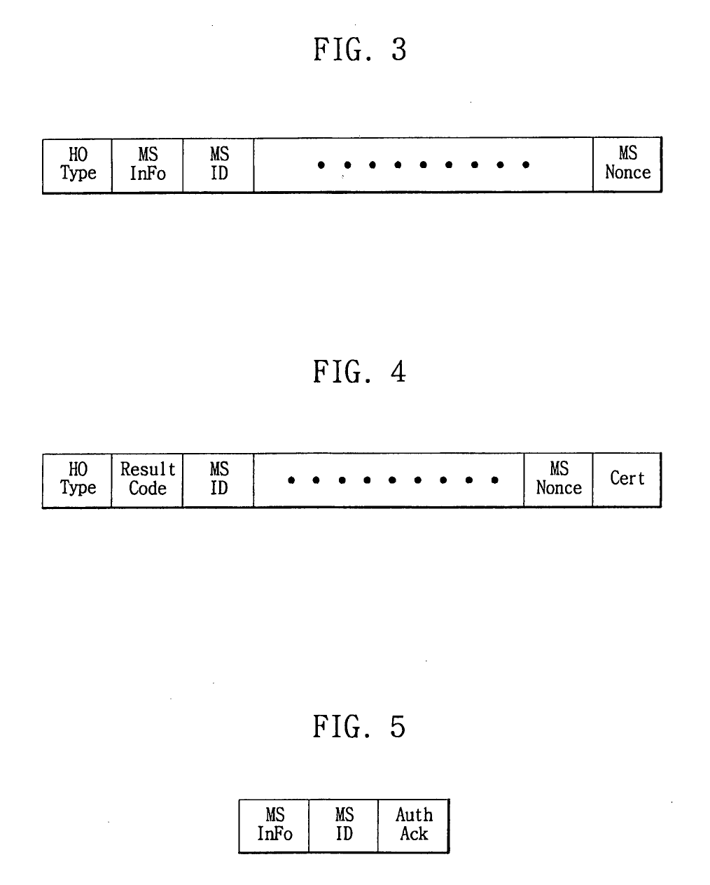

FIG. 2 is a view of a handover process performed using mutual authentication in a WiBro network according to an exemplary embodiment of the present invention. FIG. 3 is a view of the format of a HO-request message in a TBS authentication process of FIG. 2. FIG. 4 is a view of the format of a HO-response message in the TBS authentication process of FIG. 2. FIG. 5 is a view of the format of a HO-acknowledge message in the TBS authentication process of FIG. 2.

As illustrated in FIG. 2, the MS 100 connected to the SBS 200 is attempting handover to the TBS 300 while receiving service. The ASN GW 400 also serves as an AAA server, but can be applied to the present invention in the same way even when its role is separated from that of an AAA server.

In particular, in the present invention, an authentication-related field is added to a HO-request message, a HO-response message and a HO-acknowledge message among messages used for TBS authentication of the MS 100 in a conventional handover process. In addition, a HMAC/CMAC tuple is applied to verify ranging messages for the sake of MS authentication of the TBS 300.

The MS 100 and the SBS 200 have already performed mutual authentication before handover and are sharing a security context, such as an authentication key, between them, etc. The MS 100 located in the service area of the SBS 200 generates a nonce value for the SBS 200 to begin a challenge-response process for authenticating the TBS 300, and transmits a HO-request message MOB_MSHO-REQ including the generated nonce value to the SBS 200 (step 10).

When the HO-request message MOB_MSHO-REQ is received from the MS 100, the SBS 200 transfers a request message for handover HO-Request (MSID and Nonce) to the TBS 300 (step 20). The HO-request message HO-Request (MSID and Nonce) transferred from the SBS 200 is first transferred to the ASN GW 400, and then is relayed to the TBS 300 by the ASN GW 400 (step 30).

An MSID included in the HO-request message HO-Request (MSID and Nonce) is an ID of the MS 100, and a nonce denotes a nonce value for the SBS 200 to begin the challenge-response process for authenticating the TBS 300.

More specifically, the format of the modified HO-request message for providing the nonce value is as shown in FIG. 3, and respective fields are described in Table 1 below.

TABLE 1

| Information Element | | Mandatory/ |
|---|---|---|
| (IE) Name | Description | Optional (M/O) |
| HO Type | Describes type of the HO (Fast | M |
| | BS Switching (FBSS), Macro | |
| | Diversity HO (MDHO) and | |
| | Hard HO (HHO)) | |
| MS Info | Contains HO-related MS | M |
| | context in the nested IFs. | |
| MS ID | 6 Octet MS ID (Media Access | M |
| | Control (MAC) Address) | |
| . . . | . . . | . . . |
| MS Nonce | MS generated one time | O |
| | random number | |

As shown in Table 1, a field “MS Nonce” is newly added in the format of the modified HO-request message, which includes 13 mandatory fields, 14 optional fields and 1 proposed field, and thus a random number can be stored.

Subsequently, when the HO-request message HO-Request (MSID and Nonce) is relayed to the TBS 300 by the ASN GW 400, the TBS 300 requests the ASN GW 400 for an AK context of the corresponding MSID and receives the related information (Context-Request/Report: step 40).

Then, the TBS 300 receiving the HO-request message HO-Request (MSID and Nonce) including the nonce value transferred from the SBS 200 and the AK context-related information of the MSID transferred from the ASN GW 400, transfers a modified HO-response message HO-Response (E_{AK}[Nonce//Cert]) to the HO-request message HO-Request (MSID and Nonce) transferred from the SBS 200 to the ASN GW 400 (step 50).

The TBS 300 encodes the nonce and the certification included in the modified HO-response message HO-Response (E_{AK}[Nonce//Cert]) using an AK and transfers the encoded nonce and certification.

Subsequently, the ASN GW 400 relays the modified HO-response message HO-Response (E_{AK}[Nonce//Cert]) transferred from the TBS 300 to the SBS 200 (step 60).

The format of the modified HO-response message HO-Response (E_{AK}[Nonce//Cert]) is as shown in FIG. 4, and respective fields are described in Table 2 below.

TABLE 2

| Information Element (IE) | | Mandatory/ |
|---|---|---|
| Name | Description | Optional (M/O) |
| HO Type | Describes type of the HO | M |
| | (FBSS, MDHO and HHO) | |
| Result Code | The result of the Request | M |
| MS ID | 6 Octet MS ID (MAC | M |
| | Address) | |
| . . . | . . . | . . . |
| MS Nonce | MS generated one time | O |
| | random number | |
| Cert | Manufacturer's Certification | O |
| | or ASP's Certification | |

As shown in Table 2, fields “MS Nonce” and “Cert” are newly added in the format of the modified HO-response message, which includes 12 mandatory fields, 7 optional fields and 2 proposed fields, and a random number is stored in the MS Nonce field.

Subsequently, the SBS 200 receiving the modified HO-response message HO-Response (E_{AK}[Nonce//Cert]) from the TBS 300, transmits a MOB_MSHO-RSP message to the MS 100 (step 70).

Then, the SBS 200 verifies the encoded nonce and certification in the modified HO-response message HO-Response (E_{AK}[once//Cert]) transferred from the TBS 300, and transfers a modified HO-acknowledge message for providing an authentication result for the TBS 300 to the ASN GW 400 (step 80).

In other words, when the modified HO-response message HO-Response (E_{AK}[Nonce//Cert]) is received from the TBS 300, the SBS 200 decodes the encoded nonce and certification. As shown in Table 2 above, the certification denotes a TBS manufacturer's certification or a TBS ASP's certification.

In this way, when the encoded nonce and certification are decoded as mentioned above, the SBS 200 first compares a nonce value that it has with the decoded nonce value. When the nonce value of the SBS 200 is the same as the decoded nonce value, and also the decoded certification is a normal one, the SBS 200 transfers the modified HO-acknowledge message for providing the authentication result for the TBS 300 to the ASN GW 400.

Subsequently, the ASN GW 400 relays the modified HO-acknowledge message transferred from the SBS 200 to the TBS 300 (step 90), thereby finishing the TBS authentication process, i.e., a challenge-response scheme.

The format of the modified HO-acknowledge message for providing the TBS authentication result is as shown in FIG. 5, i.e., 2 mandatory fields and 1 proposed field, and respective fields are described in Table 3 below.

TABLE 3

| Information Element (IE) | | Mandatory/ |
|---|---|---|
| Name | Description | Optional (M/O) |
| MS Info | Contains HO-related MS | M |
| | context in the nested IFs. | |
| MS ID | 6 Octet MS ID (MAC | M |
| | Address) | |
| Auth Ack | The result of TBS | O |
| | authentication | |

As shown in Table 3, a field “Auth Ack” is newly added in the format of the modified HO-acknowledge message, which includes 2 mandatory fields and 1 proposed field.

When the TBS authentication process, i.e., the challenge-response scheme, is finished, the MS 100 transmits a MOB_HO-IND message to the SBS 200 (step 100). The SBS 200 receiving the MOB_HO-IND message from the MS 100 transfers a HO_confirm (TEK context) message to the ASN GW 400 (step 110).

Subsequently, the ASN GW 400 relays the HO_confirm (TEK context) message transferred from the SBS 200 to the verified TBS 300 (step 120).

Then, the TBS 300 transfers a HO-acknowledge message to the HO_confirm (TEK context) message transferred from the SBS 200 to the ASN GW 400 (step 130), and the ASN GW 400 relays the HO-acknowledge message transferred from the TBS 300 to the SBS 200 (step 140).

Subsequently, when the MS 100 transmits an RNG-REQ (CMAC or HMAC) message to be authenticated by the TBS 300 to the TBS 300 (step 150), the TBS 300 transmits an RNG-RSP (CMAC or HMAC) message to the RNG_REQ (CMAC or HMAC) message transmitted from the MS 100 to the MS 100 (step 160).

In other words, the MS 100 and the TBS 300 are already sharing the same AK and thus each can generate a CMAC key or HMAC key from the AK and a nonce as given below.

CMAC_KEY=modified_Dot16KDF(AK, SS MAC Address//BSID//“CMAC_KEYS+KEK”, 384, Nonce)

HMAC_KEY=modified_Dot16KDF(AK, SS MAC Address//BSID//“HMAC_KEYS+KEK”, 448, Nonce)

Thus, in the above-described ranging process, the MS 100 generates a CMAC value for the ranging message using the generated CMAC key, and then transmits it to the TBS 300.

Then, the TBS 300 receiving the CMAC value from the MS 100 also generates a CMAC value using its own CMAC key. When the generated CMAC value is the same as the CMAC value transferred from the MS 100, the TBS 300 can authenticate the ranging message itself and also the MS 100 by certifying that the AK and nonce of the TBS 300 are the same as those of MS 100.

As described above, the present invention includes an authentication process indispensable for a handover process of a WiBro terminal in a basic handover process and omits a conventional authentication process for security, thereby more efficiently performing handover.

According to the present invention, an authentication process indispensable for a handover process without a process exchanging an additional message, such as a PKM phase, a TEK-related phase, etc., in a conventional WiBro network, is included in a basic handover process, and thus it is possible to provide a more efficient handover function by seamless service and improve security by a mutual authentication function.

While the present invention has been described with reference to exemplary embodiments thereof, it will be understood by those skilled in the art that various modifications in form and detail may be made therein without departing from the scope of the present invention as defined by the following claims.

What is claimed is:

1. A method of performing a handover using mutual authentication in a Wireless Broadband (WiBro) network, the method comprising:
generating a temporary number of a mobile station needing handover from a first base station to a second base station and requesting a handover from the first base station;
transferring a handover request message, including a field for storing the temporary number of the mobile station, from the first base station to the second base station according to the handover request of the mobile station;
transferring a handover response message, including respective fields for storing the mobile station's temporary number and the second base station's certification encoded using an authentication key received from an authentication server, from the second base station to the first base station;
verifying the encoded temporary number of the mobile station and the encoded certification of the second base station in the handover response message transferred from the second base station, and transferring a handover acknowledge (ACK) message including a field for storing an authentication result for the second base station, from the first base station to the second base station;
transmitting an initial communication request message, including a Control Mobile Attenuation Code (CMAC) value to be authenticated by the second base station, from the mobile station to the second base station; and
authenticating the mobile station and transmitting a response message to the initial communication request message, from the second base station to the mobile station in response to the CMAC value transmitted from the mobile station being the same as a CMAC value of the second base station.

2. The method of claim 1, wherein transferring the handover request message to the second base station comprises the authentication server relaying the handover request message to the second base station.

3. The method of claim 2, wherein the temporary number of the mobile station comprises the mobile station's nonce value for authenticating the second base station when transferring the handover request message to the second base station.

4. The method of claim 1, wherein transferring the handover response message to the first base station comprises the authentication server relaying the handover response message to the first base station.

5. The method of claim 4, wherein the temporary number of the mobile station comprises the mobile station's nonce value for authenticating the second base station, and wherein the certification of the second base station comprises a certification of the second base station's manufacturer or Application Service Provider (ASP) when transferring the handover response message to the first base station.

6. The method of claim 1, wherein transferring the handover ACK message to the second base station comprises the authentication server relaying the handover ACK message to the second base station.

7. The method of claim 6, wherein transferring the handover ACK message to the second base station comprises the first base station decoding the encoded temporary number of the mobile station and the encoded certification of the second base station in the handover response message, and transferring the handover ACK message including the field for storing an authentication result for the second base station to the second base station in response to the decoded temporary number of the mobile station being the same as a temporary number of the mobile station that the first base station has, and the certification of the second base station being normal.

8. The method of claim 1, wherein transmitting the initial communication request message to the second base station comprises the mobile station generating the CMAC value using a CMAC key generated from the authentication key shared with the second base station and the temporary number of the mobile station, and then transmitting the initial communication request message including the CMAC value to the second base station.

9. The method of claim 8, wherein transmitting the response message to the initial communication request message to the mobile station comprises the second base station authenticating the mobile station and transmitting the response message to the initial communication request message to the mobile station in response to the CMAC value of the mobile station being the same as the CMAC value generated using a CMAC key generated from the authentication key of the second base station.

10. The method of claim 9, wherein the second base station authenticates the mobile station by certifying identity of the authentication key and the temporary number of the mobile station in response to the CMAC value of the mobile station being the same as the CMAC value of the second base station.

11. A method of authenticating a handover target base station in a Wireless Broadband (WiBro) network, the method comprising:
generating a temporary number of a mobile station needing a handover from a first base station to a second base station and requesting a handover from the first base station;
transferring a handover request message, including a field for storing the temporary number of the mobile station, from the first base station to the second base station according to the handover request of the mobile station;
transferring a handover response message, including respective fields for storing the mobile station's temporary number and the second base station's certification encoded using an authentication key received from an authentication server, from the second base station to the first base station; and
verifying the encoded temporary number of the mobile station and the encoded certification of the second base station in the handover response message transferred from the second base station, and transferring a handover acknowledge (ACK) message, including a field for storing an authentication result for the second base station, from the first base station to the second base station.

12. The method of claim 11, wherein transferring the handover request message to the second base station comprises the authentication server relaying the handover request message to the second base station.

13. The method of claim 12, wherein the temporary number of the mobile station comprises the mobile station's nonce value for authenticating the second base station when transferring the handover request message to the second base station.

14. The method of claim 11, wherein the authentication server relays the handover response message to the first base station when transferring the handover response message to the first base station.

15. The method of claim 14, wherein the temporary number of the mobile station comprises the mobile station's nonce value for authenticating the second base station, and wherein the certification of the second base station is a certification of the second base station's manufacturer or Application Service Provider (ASP) when transferring the handover response message to the first base station.

16. The method of claim 11, wherein the authentication server relays the handover ACK message to the second base station when transferring the handover ACK message to the second base station.

17. The method of claim 16, wherein transferring the handover ACK message to the second base station comprises the first base station decoding the encoded temporary number of the mobile station and the encoded certification of the second base station in the handover response message, and transferring the handover ACK message, including the field for storing an authentication result for the second base station, to the second base station in response to the decoded temporary number of the mobile station being the same as a temporary number of the mobile station that the first base station has, and the certification of the second base station being normal.

18. A method of authenticating a mobile station in a Wireless Broadband (WiBro) network, the method comprising:
transmitting an initial communication request message, including a Control Mobile Attenuation Code (CMAC) value to be authenticated by a second base station, from a mobile station needing a handover to the second base station; and
authenticating the mobile station and transmitting a response message to the initial communication request message from the second base station to the mobile station in response to the CMAC value transmitted from the mobile station being the same as a CMAC value of the second base station.

19. The method of claim 18, wherein transmitting the initial communication request message to the second base station comprises the mobile station generating the CMAC value, using a CMAC key generated from an authentication key shared with the second base station and a temporary number of the mobile station, and then transmitting the initial communication request message, including the CMAC value, to the second base station.

20. The method of claim 19, wherein transmitting the response message to the initial communication request message to the mobile station comprises the second base station authenticating the mobile station and transmitting the response message to the initial communication request message to the mobile station in response to the CMAC value of the mobile station being the same as the CMAC value generated using a CMAC key generated from the authentication key of the second base station.

21. The method of claim 20, wherein the second base station authenticates the mobile station by certifying identity of the authentication key and the temporary number of the mobile station in response to the CMAC value of the mobile station being the same as the CMAC value of the second base station.

22. A system to perform a handover using mutual authentication in a Wireless Broadband (WiBro) network, the system comprising:
a mobile station;
a first base station; and
a second base station;
wherein the mobile station generates a temporary number thereof and requests the first base station for a handover when requesting a handover from the first base station to the second base station;
wherein the first base station transfers a handover request message, including a field for storing the temporary number of the mobile station, to the second base station according to the handover request of the mobile station;
wherein the second base station transfers a handover response message, including respective fields for storing the mobile station's temporary number and the second base station's certification encoded using an authentication key received from an authentication server connected through a network, to the first base station;
wherein the first base station verifies the encoded temporary number of the mobile station and the encoded certification of the second base station in the handover response message transferred from the second base station, and transfers a handover acknowledge (ACK) message, including a field for storing an authentication result for the second base station to the second base station; and
wherein the second base station authenticates the mobile station and transmits a response message to the initial communication request message to the mobile station in response to an initial communication request message including a Control Mobile Attenuation Code (CMAC) value received from the mobile station, and the received CMAC value of the mobile station being the same as a CMAC value of the second base station.

23. The system of claim 22, wherein the authentication server relays the handover request message to the second base station.

24. The system of claim 23, wherein the temporary number of the mobile station comprises the mobile station's nonce value for authenticating the second base station.

25. The system of claim 22, wherein the authentication server relays the handover response message to the first base station.

26. The system of claim 25, wherein the temporary number of the mobile station comprises the mobile station's nonce value for authenticating the second base station, and wherein the certification of the second base station comprises a certification of the second base station's manufacturer or Application Service Provider (ASP).

27. The system of claim 22, wherein the authentication server relays the handover ACK message to the second base station.

28. The system of claim 27, wherein the first base station decodes the encoded temporary number of the mobile station and the encoded certification of the second base station in the handover response message, and transfers the handover ACK message, including the field for storing an authentication result for the second base station to the second base station, in response to the decoded temporary number of the mobile station being the same as a temporary number of the mobile station that the first base station has, and the certification of the second base station being normal.

29. The system of claim 22, wherein the mobile station generates the CMAC value using a CMAC key generated from the authentication key shared with the second base station and the temporary number of the mobile station, and then transmits the initial communication request message, including the CMAC value, to the second base station.

30. The system of claim 29, wherein the second base station authenticates the mobile station and transmits the response message to the initial communication request message to the mobile station in response to the CMAC value of the mobile station being the same as the CMAC value generated using a CMAC key generated from the authentication key of the second base station.

31. The system of claim 30, wherein the second base station authenticates the mobile station by certifying identity of the authentication key and the temporary number of the mobile station in response to the CMAC value of the mobile station being the same as the CMAC value of the second base station.
